(19) United States
(12) Patent Application Publication
(10) Pub. No.: US 2026/0358236 A1
(43) Pub. Date: Nov. 12, 2026

(54) CORROSION SENSOR FOR A NITRIC ACID MEDIUM, AND ASSOCIATED CORROSION MEASUREMENT DEVICE AND FACILITY

(71) Applicant: COMMISSARIAT A L'ENERGIE ATOMIQUE ET AUX ENERGIES ALTERNATIVES, Paris (FR)

(72) Inventors: Emilie SCHEERS, Fleury Les Aubrais (FR); Nathalie GRUET, Bretigny Sur Orge (FR); Olivier GENEVE, Saint Michel Sur Orge (FR); Emmanuel SCORSONE, Magny Les Hameaux (FR)

(73) Assignee: COMMISSARIAT A L'ENERGIE ATOMIQUE ET AUX ENERGIES ALTERNATIVES, Paris (FR)

(21) Appl. No.: 19/129,927

(22) PCT Filed: Nov. 15, 2023
(86) PCT No.: PCT/EP2023/081840

§ 371 Date: May 14, 2025

(30) Foreign Application Priority Data
Nov. 15, 2022 (FR) FR2211865

(51) Int. Cl. G01N 17/02

(52) U.S. Cl. CPC G01N 17/02

(57) ABSTRACT

A corrosion sensor includes a body made of one or more materials that can withstand the acid medium having cavities, a working electrode including a contact surface made of one or more electrically conductive materials, a reference electrode including a contact surface made of one or more electrically conductive materials that can withstand the acid medium, a counter electrode including a contact surface made of one or more electrically conductive materials that can withstand the acid medium, the electrode forms an electrical circuit with the working electrode, three seals made of one or more electrically insulating materials that can withstand the acid medium, each of the seals being accommodated in a cavity in the body and sealingly surrounding one of the electrodes while leaving the contact surfaces thereof exposed, the corrosion sensor measures the impedance of the electrical circuit by applying an electrical potential to the working electrode.

### TECHNICAL FIELD

The present invention relates to the field of corrosion sensors, particularly for corrosion in a strong acid medium, such as a nitric acid medium.

The present invention notably relates to a corrosion sensor for a concentrated and hot nitric acid medium, which is to say an aqueous medium in which the temperature is comprised between 20 °C and 135 °C and comprising a nitric acid concentration of between 2 and 5 mol/L.

The present invention is not restricted solely to applications in a nitric acid medium and it is conceivable to use it for other types of acid medium or in neutral mediums, such as those encountered in wastewater.

### PRIOR ART

In numerous applications and facilities in corrosive mediums, it is of key importance to monitor the corrosion of the immersed elements notably in order to monitor the aging of the facilities.

For certain facilities, such as a nuclear fuel reprocessing plant, corrosion is generally monitored by measurement using ultrasound and/or that relies on predictive models.

However, taking ultrasound measurements entails shutting down the facility and is unable to monitor corrosion at certain points in the facility. Specifically, monitoring corrosion by ultrasound measurement assumes that the speed of propagation of the ultrasound waves in the material being monitored is known, so that the remanent thickness can be determined. This echography method for monitoring corrosion is therefore suitable for a material the surface of which is sufficiently smooth, and the corrosion of which is uniform dissolution.

However, for a surface of excessively high roughness, the noise generated by the diffusion of the ultrasound waves renders spectral analysis impossible.

This is why predictive models are employed. These predictive models are based on experimental results obtained in the laboratory under stable and predefined operating conditions. However, these models are not optimal because they require perfect knowledge and control of the chemistry of the medium of the facility. In addition, these models are ill-suited to the unknowns that may arise when the facility is in operation: they are unable to take changes to the corrosive power of the medium of the facility into consideration.

Moreover, there are corrosion-monitoring devices that employ electrochemical techniques. At the present time, these devices are ill-suited to mediums with a high corrosive power, such as nitric acid mediums. Specifically, these devices require the use of a reference electrode of which the potential needs to remain relatively stable in the hot and corrosive medium over the course of time and, at this time, this is proven to be unachievable in corrosive mediums in which the temperature exceeds 60 °C.

There is therefore still a need for an in-situ and real-time corrosion-monitoring sensor that overcomes the aforementioned disadvantages.

In particular, there is still a need for a corrosion sensor for monitoring corrosion in a neutral or acid medium, notably a hot concentrated nitric acid medium, in situ, in real-time, and non-destructively.

The aim of the invention is to at least partly meet this need/these needs.

### SUMMARY OF THE INVENTION

In order to do this, the invention relates to a corrosion sensor for monitoring corrosion in a neutral or acid medium, the corrosion sensor comprising:
a body made of one or more materials that can withstand the acid medium, and comprising cavities,
a working electrode comprising a contact surface made of one or more electrically conductive materials and to which a measurement electrical potential is intended to be applied,
a reference electrode, comprising a contact surface made of one or more electrically conductive materials that can withstand the acid medium;
a counter-electrode comprising a contact surface made of one or more electrically conductive materials that can withstand the acid medium and which is intended to form an electrical circuit with the working electrode in the neutral or acid medium;
three seals made of one or more electrically insulating materials that can withstand the neutral or acid medium, each of the seals being accommodated in a cavity of the body and sealingly surrounding one of the electrodes that are the working electrode, the reference electrode and the counter-electrode while leaving the contact surfaces of said electrodes exposed,
   the corrosion sensor being configured to measure the impedance of the electrical circuit by applying the measurement electrical potential and thereby determine the resistance of the working electrode to corrosion in the neutral or acid medium.

The reference electrode advantageously has a reference electrical potential that is stable in a neutral or acid medium, notably in a nitric acid medium.

What is meant by an “acid medium” in the sense of the present invention is a liquid medium with a pH of less than 6; the acid medium may notably be a strong acid medium, which is to say an acid medium with a pH of less than 2.

Likewise, a “neutral medium” is a liquid medium with a pH of between 6 and 8. For example, a neutral medium may consist of wastewater.

A material that is resistant to an acid medium is such that when immersed in said medium it does not corrode. The materials that are resistant to the acid mediums may be resistant to mediums containing a strong acid and a solvent. For example, the materials that are resistant to the acid mediums may be resistant to mediums containing a strong acid and a solvent, the solvent being water and the strong acid being sulfuric acid or nitric acid. The concentration of said strong acids may be greater than 2 mol/L and/or said mediums may be at a temperature comprised between 20 °C and 135 °C. For example, the materials that are resistant to the acid mediums may be resistant to a nitric acid medium or even to a concentrated and hot nitric acid medium.

As a preference, the area of the contact surface of the working electrode is comprised between 0.4 mm² and 75 mm² and/or the area of the contact surface of the reference electrode is comprised between 0.4 mm² and 75 mm² and/or the area of the contact surface of the counter-electrode is comprised between 0.4 mm² and 75 mm².

As a preference, the working electrode is of cylindrical shape and the contact surface of said electrode is comprised in one of the disks that form the bases of the cylinder.

As a preference, the diameter of the working electrode is comprised between 1 mm and 10 mm, and preferably equal to 3 mm, and/or the height of the working electrode is comprised between 5 mm and 10 mm, and preferably equal to 8 mm.

As a preference, the contact surface of the working electrode represents between 50% and 95% of the surface area of the disk that forms the base of the cylinder.

As a preference, the reference electrode is of cylindrical shape and the contact surface of said electrode is one of the disks that form the bases of the cylinder.

As a preference, the diameter of the reference electrode is comprised between 1 mm and 10 mm, and preferably equal to 2 mm, and/or the height of the reference electrode is comprised between 5 mm and 10 mm, and preferably equal to 8 mm.

As a preference, the contact surface of the reference electrode represents between 50% and 95% of the surface area of the disk that forms the base of the cylinder.

As a preference, the counter-electrode is of cylindrical shape and the contact surface of said electrode is one of the disks that form the bases of the cylinder.

As a preference, the diameter of the counter-electrode is greater than that of the working electrode and is comprised between 1 mm and 10 mm, and preferably equal to 5 mm, and/or the height of the counter-electrode is comprised between 5 mm and 10 mm, and preferably equal to 8 mm.

As a preference, the contact surface of the counter-electrode represents between 50% and 95% of the surface area of the disk that forms the base of the cylinder.

As a preference, the reference electrode and/or the counter-electrode are made of a noble metal such as platinum, gold, iridium or alloys of said metals.

As a preference, the body and/or the seals are made of polymer, preferably of polyether ether ketone or of a cyclic olefin copolymer.

As a preference, the body is of cylindrical shape, preferably with a diameter comprised between 50 mm and 100 mm and/or a height comprised between 30 mm and 100 mm, the cavities being produced in such a way as to leave the contact surfaces exposed from the same base of the cylinder.

As a preference, each of the seals is of hollow cylindrical shape with a hollow interior cylinder in which the working electrode, the reference electrode or the counter-electrode is intended to be set.

As a preference, each of the seals comprises an external screw thread to be screwed into one of the tapped cavities of the body.

The invention also relates to a device for measuring corrosion in a neutral or acid medium, comprising:
at least one corrosion sensor as described hereinabove,
an electronic circuit comprising an electrical-current analyzer and connecting electric wires electrically connecting the analyzer to the working electrode, the reference electrode and the counter-electrode so as to measure the potential of the working electrode with respect to the reference electrode and to measure the current flowing between the working electrode and the counter-electrode, at least the electric wires being accommodated at least partially sealingly in the body of the sensor.

As a preference, the device comprises an electromagnetic-shielding sheath able to withstand the acid medium, preferably hot concentrated nitric acid, and preferably made of polyether ether ketone or of a cyclic olefin copolymer, the analyzer being arranged outside the body, and the electric wires having a section extending out of the body and accommodated sealingly in the shielding sheath.

Another subject of the invention is a facility comprising:
a bath containing a neutral or acid solution, preferably a nitric acid solution, preferably an aqueous solution containing nitric acid at a concentration greater than 2 mol/L, the solution preferably being at a temperature comprised between 20 °C and 135 °C,
at least one corrosion sensor as described hereinabove or of the device as aforementioned, of which at least the contact surfaces of the working electrode, of the reference electrode and of the counter-electrode are in contact with the nitric acid solution.

As a preference, the facility is a nuclear fuel reprocessing plant.

According to another of its aspects, the invention relates to a method for operating a corrosion sensor as described hereinabove, comprising the following steps:
a/ measuring how the impedance of the electrical circuit comprising the working electrode and the counter-electrode evolves over a given time interval;
b/ determining the rate of corrosion of the material of the working electrode from the evolution in impedance measured in step a/.

The present invention essentially therefore consists in a corrosion sensor configured so that, when immersed in a neutral or acid medium, for example a nitric acid medium, only the contact surfaces of the working electrode, of the reference electrode and of the counter-electrode are in contact with said neutral or acid medium, the rest of said electrodes being accommodated sealingly inside a body by means of seals and thus hermetically isolated from said neutral or acid medium.

By limiting the contact between the neutral or acid medium and the reference electrode to a chosen contact surface, the stability, over the course of time, of the potential of the reference electrode is improved.

Thus, the corrosion sensor according to the present invention has the advantage that the potential of the reference electrode remains relatively stable in the neutral or acid medium, particularly in a hot concentrated nitric acid medium.

Furthermore, by limiting the contact between the neutral or acid medium and the working electrode to a chosen contact surface, it is simpler to monitor how the corrosion evolves using the perfectly calibrated geometric characteristics of said electrode.

The body and the seals also provide protection for the electric wires that connect the electrodes to an electric-current analyzer.

Advantageously, the corrosion sensor is suitable for monitoring corrosion in a facility having a neutral or acid medium, notably a hot concentrated nitric acid medium, and doing so in situ, non-destructively, and in real-time, without the need to shut down the facility.

The corrosion sensor therefore provides better reliability in monitoring the aging of a facility.

Furthermore, the corrosion sensor makes it possible to reduce the cost of operation of a facility because there is no longer a need to shut down the facility in order to monitor it.

Furthermore, the corrosion sensor, the associated measurement device and the associated operation according to the present invention allow the corrosion to be monitored in its early stages, which means to say are able to monitor how the corrosion evolves without the corrosion becoming excessively advanced.

Other advantages and features will emerge more clearly on reading the detailed description, which is given by way of non-limiting illustration, with reference to the figures below.

### BRIEF DESCRIPTION OF THE DRAWINGS

FIG. 1 is a perspective view of a corrosion sensor according to the invention, the body being viewed as transparent.

FIG. 2 is a view from above of the corrosion sensor according to FIG. 1.

FIG. 3 is a view from below of the corrosion sensor according to FIG. 1.

FIG. 4 is a face-on view of the corrosion sensor according to FIG. 1.

FIG. 5 is a view in longitudinal section (on A-A) of the corrosion sensor according to FIG. 1.

FIG. 6 is a perspective view of a seal as used in a corrosion sensor according to the invention, the seal being viewed as transparent.

FIG. 7 is a perspective view of a corrosion sensor according to the invention, the body being viewed as transparent, the corrosion sensor comprising a shielding sheath.

FIG. 8 is a view from below of the corrosion sensor according to FIG. 7.

FIG. 9 is a face-on view of the corrosion sensor according to FIG. 7.

FIG. 10 is a view in longitudinal section (on A-A) of the corrosion sensor according to FIG. 7.

FIG. 11 is a schematic face-on view of a nuclear fuel reprocessing facility comprising a corrosion sensor according to the present invention.

### DETAILED DESCRIPTION

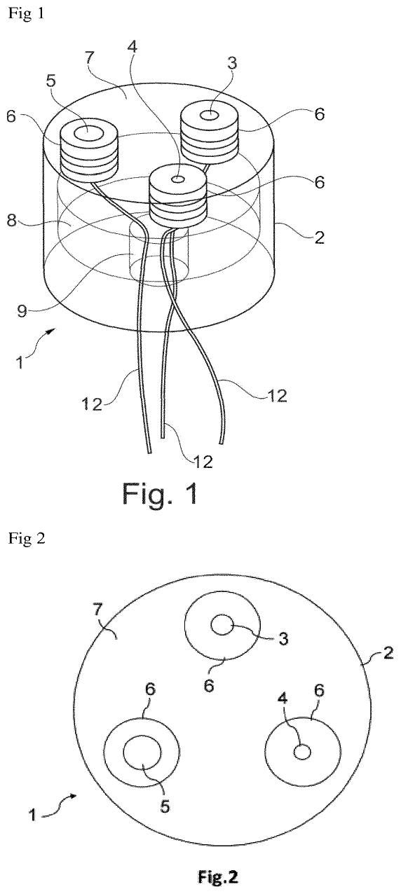

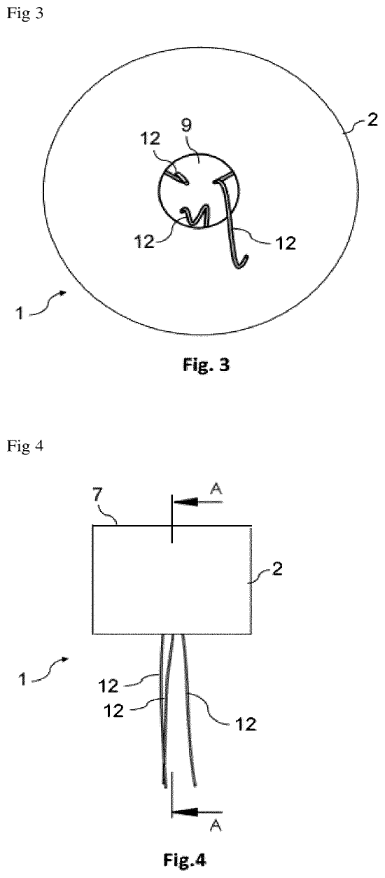

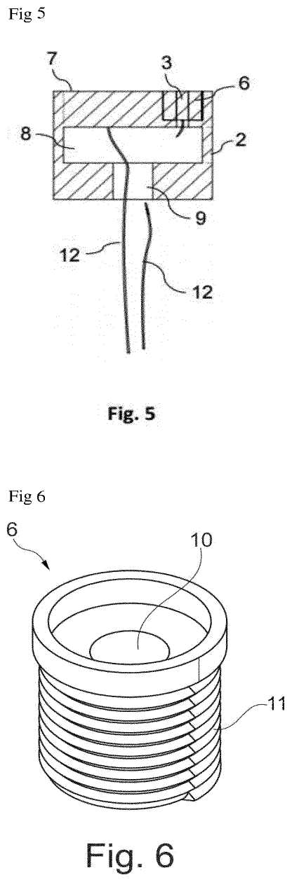

FIGS. 1 to 5 illustrate a corrosion sensor 1 according to the present invention.

The corrosion sensor 1 comprises a body 2, a working electrode 3, a reference electrode 4, a counter-electrode 5 and seals 6. The corrosion sensor 1 also comprises an electronic circuit connected to the various electrodes 3, 4 and 5 so as to measure the impedance of the electrical circuit comprising the working electrode 3 and the counter-electrode 5. Said impedance measurement is taken by measuring the potential of the working electrode 3 by measuring the current flowing between the working electrode 3 and the counter-electrode 5.

The body 2 is made of polyether ether ketone or of a cyclic olefin copolymer, but it could be made of any material able to withstand the acid mediums, notably chemically inert with respect to hot nitric acid. The body 2 has the shape of a cylinder, for example 40 mm in diameter and 30 mm in height. The body 2 comprises three cavities 20 opening to the outside, preferably all made starting from one of the disks that form the bases 7 of the cylinder.

Each cavity 20 accommodates a working electrode 3, reference electrode 4 and counter-electrode 5.

A seal 6 is interposed between each of the electrodes 3, 4 and 5 and one of the cavities 20. As a preference, each of the electrodes 3, 4 and 5 is set inside one of the seals 6. In the example illustrated, the cavities 20 and, therefore, the electrodes 3, 4 and 5 are arranged in a triangle, which means to say that each of the electrodes 3, 4 and 5 is centered on one of the vertices of an imaginary triangle, for example an equilateral triangle. This arrangement advantageously allows optimal recovery of the faradaic current generated by the oxidation or reduction of the working electrode 3. Of course, other arrangements of the electrodes 3, 4 and 5 may be envisioned without thereby departing from the scope of the invention; for example the electrodes 3, 4 and 5 may be aligned.

The working electrode 3, the reference electrode 4 and the counter-electrode 5 each have the overall shape of a solid cylinder extending along a longitudinal axis parallel to the longitudinal axis of the body 2.

The working electrode 3, the reference electrode 4 and the counter-electrode 5 are fitted into the seals 6 in such a way that only the disk representing one of the bases of their cylinders is exposed and thus in direct contact with the external medium, when the corrosion sensor 1 is immersed in said medium. The rest of each of the electrodes 3, 4 and 5 is protected inside the body 2 and thus hermetically isolated from the external medium. Thus, the seals 6 provide sealing between the walls of each of said electrodes 3, 4 and 5 and the body 2, and ensure that the inside of the body 2 is sealed against ingress.

In the embodiment illustrated in FIGS. 1 to 5, the cylinder that forms the working electrode 3 has a diameter of 3 mm and a height of 8 mm. The cylinder that forms the reference electrode 4 has a diameter of 2 mm and a height of 8 mm. The cylinder that forms the counter-electrode 5 has a diameter of 5 mm and a height of 8 mm. Other dimensions are entirely conceivable without thereby departing from the scope of the invention.

The working electrode 3 is made of a material of which it is desired to monitor how the corrosion evolves in the neutral or acid medium in which the corrosion sensor 1 is intended to be at least partially immersed. When the working electrode 3 is in contact with a neutral or acid medium, for example a hot concentrated nitric acid medium, a layer of corrosion may form at the surface of the working electrode 3 that is in contact with the acid medium. The impedance of the electrical circuit comprising the working electrode 3 and the counter-electrode 5 evolves in a manner that is inversely proportional to the rate of corrosion of the material from which the working electrode 3 is made. Thus, by thus measuring the impedance, the corrosion sensor 1 is able, by equivalence, to study and monitor, in-situ, in real-time and non-destructively, the corrosion of any component of a facility in said acid medium, the component being made from the same material as the working electrode.

The reference electrode 4 is made of a noble metal such as platinum, gold, iridium or alloys of said metals. Thus, the material from which the reference electrode 4 is made is able to withstand an acid medium as defined hereinabove, particularly a hot concentrated nitric acid medium. This advantageously enables the potential of the reference electrode 4, referred to as the reference potential, to remain relatively constant.

The counter-electrode 5 is made of platinum. Thus, the material from which the counter-electrode 5 is made is able to withstand an acid medium, particularly a hot concentrated nitric acid medium.

A seal 6 of a corrosion sensor 1 according to the invention is illustrated in FIG. 6. The seal 6 has a hollow cylindrical shape with a through-void 10 in which the working electrode 3, the reference electrode 4 or the counter-electrode 5 is intended to be set. The seal 6 has a diameter of 10 mm and a height comprised between 5 mm and 10 mm. The seal 6 also comprises a threaded part 11 for screwing the seal 6 into one of the cavities of the body 2.

The seal 6 is made of an electrically insulating material that is able to withstand acid mediums, particularly chemically inert with respect to nitric acid at temperatures comprised between 20 °C and 135 °C. For example, the seal 6 is made of polyether ether ketone or of a cyclic olefin copolymer. As a preference, the seal 6 and the body 2 are made from the same material.

Furthermore, the body 2 also comprises a void 8 and a passage 9. The passage 8 opens onto the void 8 and to the outside of the body 2 on the opposite side from that in which the electrodes 3, 4 and 5 are accommodated. Thus, the void 8 is able to house at least part of the electronic circuit for measuring the impedance of the system. It is also conceivable to arrange other electronic components in the void 8. The body 2 is advantageously able to protect the electronic circuit from the neutral or acid medium in which the corrosion sensor 1 is intended to be immersed.

The void 8 has the shape of a cylinder 35 mm in diameter and 10 mm in height.

The passage 9 allows part of the electronic circuit, for example the electric wires 12, to pass from the inside of the body 2 to the outside. For example, said electric wires 12 may pass along the passage 9 so as to electrically connect the electrodes 3, 4 and 5 to an electric-current analyzer, such as a potentiostat, in order to measure the impedance of the electrical circuit comprising the working electrode 3 and the counter-electrode 5.

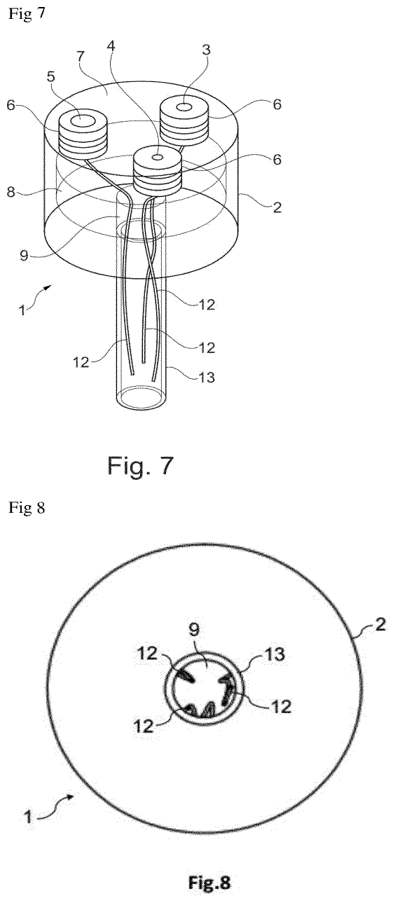

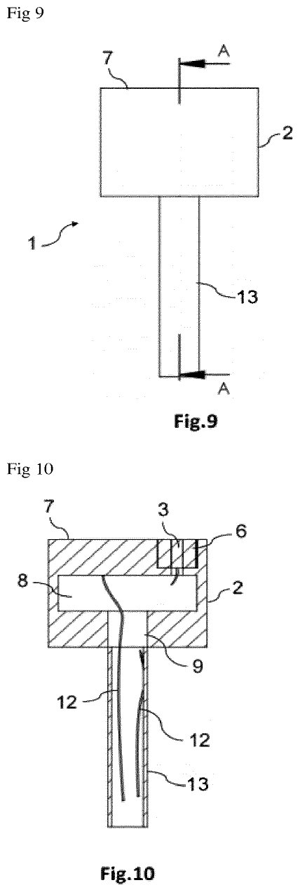

FIGS. 7 to 10 illustrate another embodiment of a corrosion sensor 1 according to the present invention. The corrosion sensor 1 is similar to that described hereinabove except that it also comprises an electromagnetic-shielding sheath 13 able to withstand the acid mediums and hermetically attached to the body 2 around the passage 9. For example, the shielding sheath 13 may be covered with a layer of diamond. The electric wires 12 are accommodated inside the shielding sheath 13. The sheath is long enough to protect the electric wires 12 from where they exit the body 2 to outside of the neutral or acid medium in which the corrosion sensor 1 is intended to be immersed. For example, the shielding sheath 13 may have a length in excess of 1 m.

The shielding sheath 13 may be in the form of a tube opening into the passage 9. For example, the shielding sheath illustrated in FIGS. 7 to 10 is a tube with a wall thickness equal to 1 mm and a diameter equal to 10 mm.

Alternatively, the electronic circuit may be accommodated in its entirety inside the body 2. For example, the electronic circuit may comprise an analyzer, such as a potentiostat, electric wires 12 for connecting the electrodes 3, 4 and 5 to the analyzer, a battery and transmission means configured for transmitting the system impedance measurements to an external data-processing system. In that case, the body 2 need not comprise a passage 9.

The corrosion sensor 1 according to the present invention may be used to monitor the corrosion of materials made from the same material as the working electrode 3 in a neutral or acid medium, for example a hot concentrated nitric acid medium. For example, the corrosion sensor 1 according to the present invention may be comprised in a facility comprising a bath of an acid solution, for example a hot concentrated nitric acid solution, for example a nuclear fuel reprocessing facility.

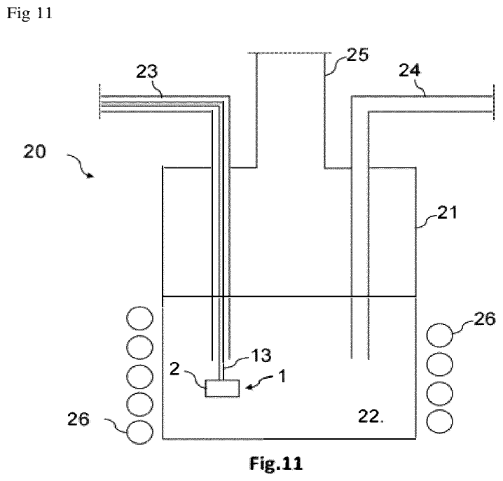

A nuclear fuel reprocessing facility 20 is illustrated in FIG. 11. The facility 20 comprises a vessel 21 containing a bath 22 of an acid, for example nitric acid (HNO₃), solution, in which bath the nuclear fuel that is to be reprocessed is intended to be immersed. The facility 20 comprises an inlet pipe 23 and an outlet pipe 24 for supplying the vessel with the acid that makes up the bath 22. An evaporate pipe 25 is arranged above the vessel 21 and configured to recover the evaporate from the bath 22. The facility 20 also comprises a heating means 26 configured to heat the bath 22 to a given temperature. The heating means 26 may, for example, comprise piping in which hot water circulates.

The facility 20 comprises a corrosion sensor 1 according to the present invention. The body 2 of the corrosion sensor 1 is immersed in the bath 22 and the shielding sheath 13 comprises a part that is immersed in the bath 22, this part being attached to the body 2, and a part that emerges out of the bath 22 and extends in the inlet pipe 23 to outside of the vessel 21. The shielding sheath 13 is thus able to protect the electric wires 12 until they are outside of the bath 22 and of the vessel 21.

The working electrode 3 of the corrosion sensor 1 may be made from the same material as the wall of the vessel 21. Thus, by measuring the corrosion of the working electrode 3, the corrosion sensor 1 is able to monitor how the corrosion of the wall of the vessel 21 evolves.

Other variants and improvements may be envisioned without thereby departing from the scope of the invention as defined by the claims below.

1. A corrosion sensor for monitoring corrosion in a neutral or acid medium, comprising:
a body made of one or more materials that can withstand the acid medium, and comprising cavities,
a working electrode comprising a contact surface made of one or more electrically conductive materials and to which a measurement electrical potential is intended to be applied,
a reference electrode, comprising a contact surface made of one or more electrically conductive materials that can withstand the acid medium;
a counter-electrode comprising a contact surface made of one or more electrically conductive materials that can withstand the acid medium and which is intended to form an electrical circuit with the working electrode in the neutral or acid medium;
three seals made of one or more electrically insulating materials that can withstand the neutral or acid medium, each of the seals being accommodated in a cavity of the body and sealingly surrounding one of the electrodes that are the working electrode, the reference electrode and the counter-electrode while leaving the contact surfaces of said electrodes exposed,
the corrosion sensor being configured to measure the impedance of the electrical circuit by applying the measurement electrical potential and thereby determine the resistance of the working electrode to corrosion in the neutral or acid medium.

2. The corrosion sensor as claimed in claim 1, the area of the contact surface of the working electrode being comprised between 0.4 mm2 and 75 mm2 and/or the area of the contact surface of the reference electrode being comprised between 0.4 mm2 and 75 mm2 and/or the area of the contact surface of the counter-electrode being comprised between 0.4 mm2 and 75 mm2 .

3. The corrosion sensor as claimed in claim 1, the working electrode being of cylindrical shape and the contact surface of said electrode being comprised in one of the disks that form the bases of the cylinder, preferably the diameter of the working electrode being comprised between 1 mm and 10 mm and/or the height of the working electrode being comprised between 5 mm and 10 mm, the contact surface of the working electrode preferably representing between 50% and 95% of the surface area of the disk that forms the base of the cylinder.

4. The corrosion sensor as claimed in claim 1, the reference electrode being of cylindrical shape and the contact surface of said electrode being one of the disks that form the bases of the cylinder, preferably the diameter of the reference electrode being comprised between 1 mm and 10 mm and/or the height of the reference electrode being comprised between 5 mm and 10 mm, the contact surface of the reference electrode preferably representing between 50% and 95% of the surface area of the disk that forms the base of the cylinder.

5. The corrosion sensor as claimed in claim 1, the counter-electrode being of cylindrical shape and the contact surface of said electrode being one of the disks that form the bases of the cylinder, preferably the diameter of the counter-electrode being greater than that of the working electrode and being comprised between 1 mm and 10 mm and/or the height of the counter-electrode being comprised between 5 mm and 10 mm, the contact surface of the counter-electrode preferably representing between 50% and 95% of the surface area of the disk that forms the base of the cylinder.

6. The corrosion sensor as claimed in claim 1, the reference electrode and/or the counter-electrode being made of a noble metal such as platinum, gold, iridium or alloys of said metals.

7. The corrosion sensor as claimed in claim 1, the body and/or the seals being made of polymer, preferably of polyether ether ketone or of a cyclic olefin copolymer.

8. The corrosion sensor as claimed in claim 1, the body being of cylindrical shape, preferably with a diameter comprised between 50 mm and 100 mm and/or a height comprised between 30 mm and 100 mm, the cavities being produced in such a way as to leave the contact surfaces exposed from the same base of the cylinder.

9. The corrosion sensor as claimed in claim 1, each of the seals being of hollow cylindrical shape with a hollow interior cylinder in which the working electrode, the reference electrode or the counter-electrode is intended to be set.

10. The corrosion sensor as claimed in claim 1, each of the seals comprising an external screw thread to be screwed into one of the tapped cavities of the body.

11. A device for measuring corrosion in a neutral or acid medium, comprising:
at least one corrosion sensor as claimed in claim 1,
an electronic circuit comprising an electrical-current analyzer and connecting electric wires electrically connecting the analyzer to the working electrode, the reference electrode and the counter-electrode so as to measure the potential of the working electrode with respect to the reference electrode and to measure the current flowing between the working electrode and the counter-electrode, at least the electric wires being accommodated at least partially sealingly in the body of the sensor.

12. The device as claimed in claim 11, comprising an electromagnetic-shielding sheath able to withstand the acid medium, preferably hot concentrated nitric acid, and preferably made of polyether ether ketone or of a cyclic olefin copolymer, the analyzer being arranged outside the body, and the electric wires having a section extending out of the body and accommodated sealingly in the shielding sheath.

13. A facility comprising:
a bath containing a neutral or acid solution, preferably a nitric acid solution, preferably an aqueous solution containing nitric acid at a concentration greater than 2 mol/L, the solution preferably being at a temperature comprised between 20 °C and 135 °C,
at least one corrosion sensor as claimed in claim 1, of which at least the contact surfaces of the working electrode, of the reference electrode and of the counter-electrode are in contact with the nitric acid solution.

14. The facility as claimed in claim 13, the facility being a nuclear fuel reprocessing plant.

15. A method for operating a corrosion sensor as claimed in claim 1, comprising the following steps:
a/ measuring how the impedance of the electrical circuit comprising the working electrode and the counter-electrode evolves over a given time interval;
b/ determining the rate of corrosion of the material of the working electrode from the evolution in impedance measured in step a/.
